(19) United States
(12) Patent Application Publication
(10) Pub. No.: US 2026/0065131 A1
(43) Pub. Date: Mar. 5, 2026

(54) ENSURING FAIRNESS IN A GENERATIVE AI MODEL VIA MODEL PRUNING

(71) Applicant: Cisco Technology, Inc., San Jose, CA (US)

(72) Inventors: Yuguang Yao, East Lansing, MI (US); Akshay Jajoo, San Jose, CA (US); Gaowen Liu, Naperville, IL (US); Yihua Zhang, East Lansing, MI (US); Ramana Rao V.R. Kompella, Foster City, CA (US); Charles Fleming, Oxford, MS (US); Myungjin Lee, Bellevue, WA (US)

(73) Assignee: Cisco Technology, Inc., San Jose, CA (US)

(21) Appl. No.: 18/821,151

(22) Filed: Aug. 30, 2024

(51) Int. Cl. G06N 20/00; G06T 11/00

(52) U.S. Cl. CPC G06N 20/00; G06T 11/00; G06T 2211/441

(57) ABSTRACT

In one implementation, a device obtains one or more terms of interest. The device also obtains one or more bias terms. The device selects a generative model configured to generate an output given a textual prompt. The device generates a debiased model by pruning neuron connections in a text encoder of the generative model associated with the one or more terms of interest and the one or more bias terms.

### TECHNICAL FIELD

The present disclosure relates generally to computer networks and more particularly to ensuring fairness in a generative artificial intelligence (AI) model via model pruning.

### BACKGROUND

Recently, generative AI has exhibited a rapid increase in its capabilities and potential uses across a wide range of industries. For instance, large language models (LLMs) such as ChatGPT and the like are able to generate text regarding a wide array of topics. In more complex scenarios, LLM-based agents are able to generate code and interact with computer systems via application programming interfaces (APIs), allowing such agents to control an underlying system or process.

One challenge with respect to generative AI relates to the issue of fairness regarding its portrayal of sensitive groups (e.g., based on race, gender, ethnicity, etc.).

For instance, consider the case of a text-to-image model that is asked to generate an image of an Indian person. One example of bias present in such a model would be if the model almost always returns images of an elderly man with a beard. However, removing all instances of bias in the training dataset for a generative model can be difficult, if not impossible or impractical, in most cases.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of interfacing with a generative artificial intelligence (AI) model;

FIG. 4 illustrates an example architecture for ensuring fairness in a generative AI model;

FIG. 5 illustrates an example of pruning connections within a text encoder; and

FIG. 6 illustrates an example simplified procedure for ensuring fairness in a generative AI model, in accordance with one or more implementations described herein.

### DESCRIPTION OF EXAMPLE IMPLEMENTATIONS

### Overview

According to one or more implementations of the disclosure, a device obtains one or more terms of interest. The device also obtains one or more bias terms. The device selects a generative model configured to generate an output given a textual prompt. The device generates a debiased model by pruning neuron connections in a text encoder of the generative model associated with the one or more terms of interest and the one or more bias terms.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

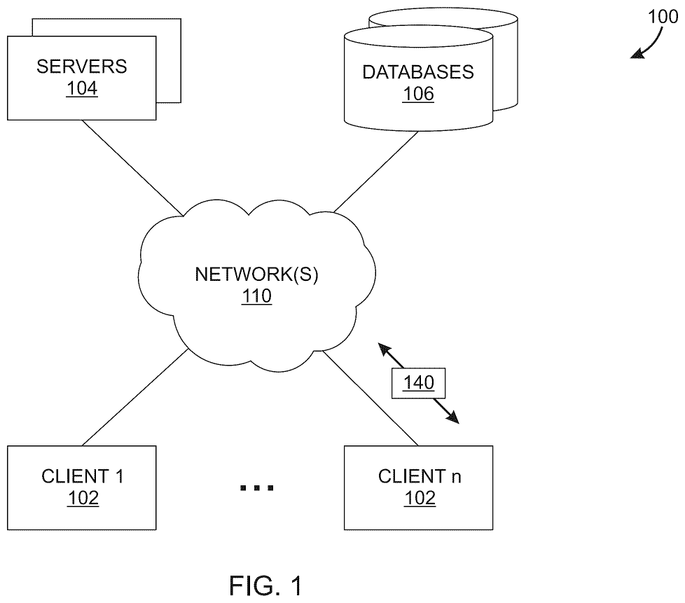

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on Wi-Fi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

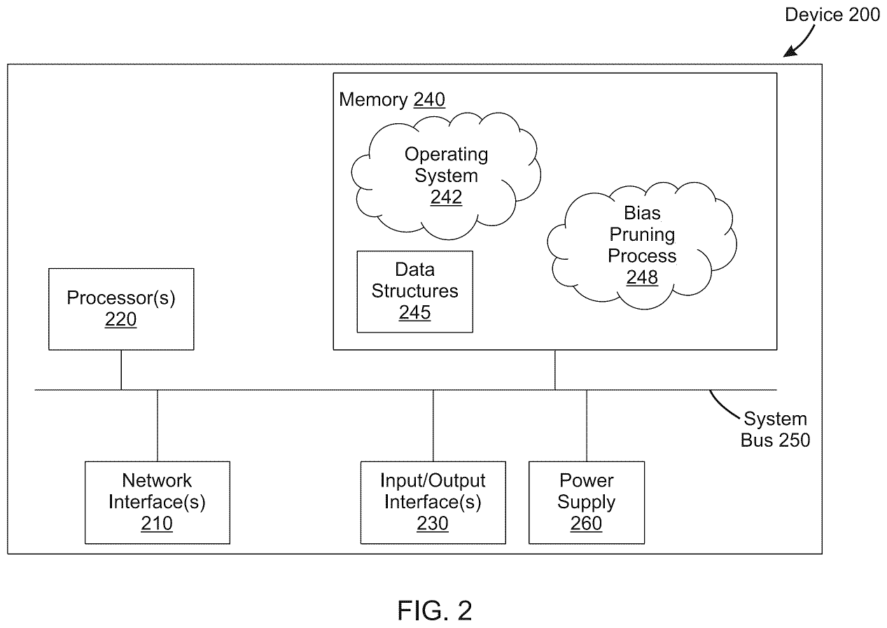

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a bias pruning process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, bias pruning process 248 may include computer executable instructions that, when executed by processor 220, cause device 200 to perform the techniques described herein. To do so, in some implementations, bias pruning process 248 may utilize and/or be a component of an artificial intelligence (AI)/machine learning system. In general, AI/machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, bias pruning process 248 may include one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the bias pruning process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, bias pruning process 248 may also include, or otherwise use or be employed to operate with, one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, bias pruning process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs), other transformer models, diffusion models, and the like.

The performance of an AI/machine learning model can be evaluated in a number of ways based on the number of true positives, false positives, true negatives, and/or false negatives of the model. For example, consider the case of a model that predicts whether the QoS of a network path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

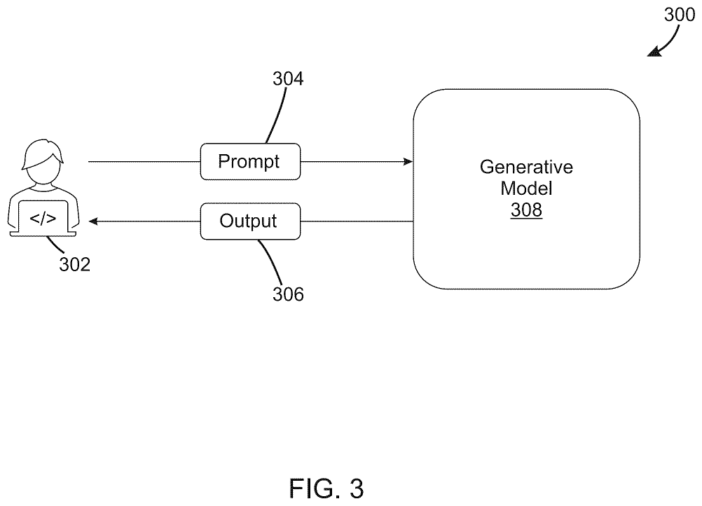

FIG. 3 illustrates an example 300 for interfacing with a generative AI model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM), diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, audio, video, combinations thereof, or the like.

As noted above, one challenge with respect to generative AI models, such as generative model 308, is that is difficult, if not impossible, to remove all bias from its training dataset. For instance, consider the case in which generative model 308 is a text-to-image (T2I) model that generates output 306 in the form of an image, in response to prompt 304, which may be a textual description of the image desired by user 302. In cases in which prompt 304 includes one or more topics of interest, the resulting image in output 306 may exhibit bias with respect to the person or people depicted in the image (e.g., in terms of the depicted person's race, ethnicity, gender, etc.). For instance, one example of bias would be if user 302 asks generative model 308 to create an image of an Indian person and generative model 308 almost always returns images of an elderly man with a beard.

### Ensuring Fairness in a Generative AI Model via Model Pruning

The techniques introduced herein ensure fairness in a generative AI model by removing bias from the model using a model compression/pruning approach. In some aspects, the techniques herein allow a user to specify the topics and bias terms to be debiased from the model via a user interface.

Illustratively, the techniques described herein may be performed by hardware, software, and/or firmware, such as in accordance with bias pruning process 248, which may include computer executable instructions executed by the processor 220 (or independent processor of interfaces 210) to perform functions relating to the techniques described herein.

Specifically, according to various implementations, a device obtains one or more terms of interest. The device also obtains one or more bias terms. The device selects a generative model configured to generate an output given a textual prompt. The device generates a debiased model by pruning neuron connections in a text encoder of the generative model associated with the one or more terms of interest and the one or more bias terms.

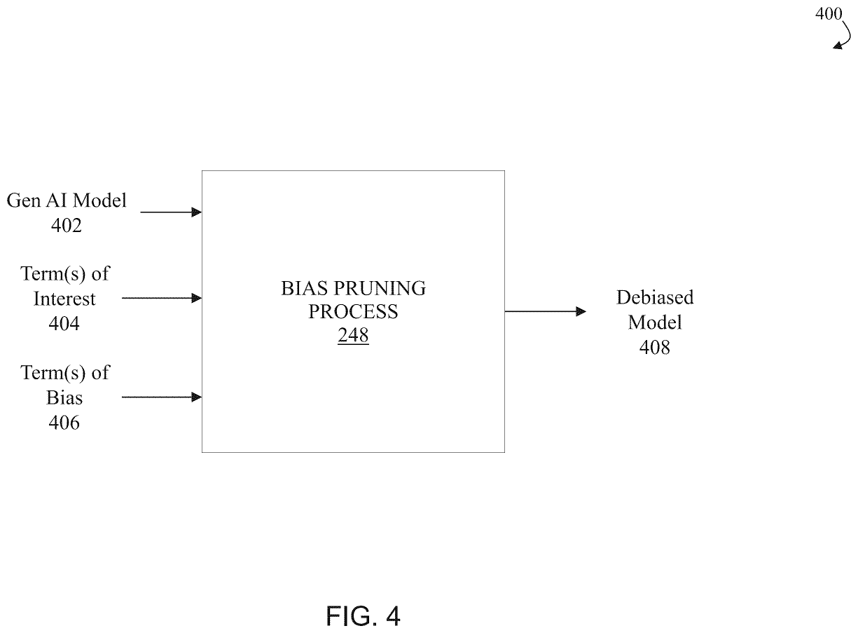

Operationally, FIG. 4 illustrates an example architecture 400 for ensuring fairness in a generative AI model, in various implementations. At the core of architecture 400 is bias pruning process 248, which may be executed by a controller for a network, a networking device, a sever, an endpoint, or the like (e.g., a device 200).

In various implementations, bias pruning process 248 may obtain any or all of the following: a generative AI model 402, term(s) of interest 404, and/or term(s) of bias 406. In response, bias pruning process 248 may perform pruning on generative AI model 402 with respect to term(s) of interest 404 and term(s) of bias 406, to generate debiased model 408, which is a version of generative AI model 402 that has been reconfigured to exhibit greater fairness/less bias in its outputs. In turn, bias pruning process 248 may deploy debiased model 408 as a replacement for generative AI model 402.

To obtain term(s) of interest 404, term(s) of bias 406, and/or a selection of generative AI model 402 for debiasing, bias pruning process 248 may interact with a user interface, to allow a user to make these selections. For instance, such a user interface may allow the user to select which model is to be debiased from among a set of existing models. In addition, the user interface may allow the user to select the term(s) of interest and bias from among predefined sets or to manually enter them.

In general, term(s) of interest 404 may correspond to terms that a user may use in an input prompt to generative AI model 402 and are potentially subject to bias. For instance, in the case of the user requesting the model generate an output depicting one or more people, term(s) of interest 404 may take the form of one or more types of people (e.g., a person's occupation, ethnicity, activity, etc.).

Similarly, term(s) of bias 406 may take the form of terms that relate to a person's race, ethnicity, gender, age, or other sensitive category. In other words, the selection of these terms in combination with term(s) of interest 404 may correspond to a request that bias pruning process 248 adjust generative AI model 402 such that its outputs related to term(s) of interest 404 are not biased towards any of the categories of term(s) of bias 406.

By way of example, assume that generative AI model 402 is a stable diffusion model configured as a V2I model. As would be appreciated, a stable diffusion model operate by adding Gaussian noise as part of a forward diffusion process and reverse that diffusion by performing denoising. This allows the model to learn to generate pixels of an image. By learning a joint encoding space for text and images, generative AI model 402 is then able to relate text embeddings (i.e., vector representations of terms) with image embeddings), thereby allowing it to generate images that represent what a user requests via text. To this end, generative AI model 402 may also include a text encoder configured to convert the terms of the input prompt into embeddings.

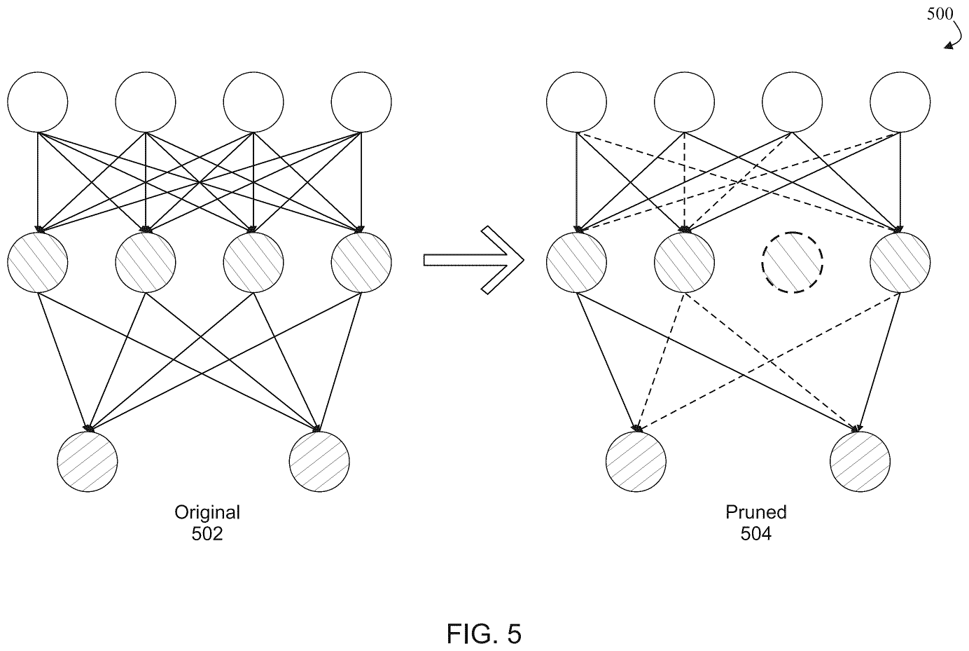

Thus, there are several modules in a stable diffusion model that bias pruning process 248 could prune: 1.) image encoders, 2.) image decoders, 3.) text encoders, 4.) cross attention, and/or 5.) self-attention. By way of example, consider the case in which bias pruning process 248 is configured to prune the text encoder of generative AI model 402 to generate debiased model 408. FIG. 5 illustrates an example 500 of bias pruning process 248 pruning connections within such a text encoder.

To debias the output, bias pruning process 248 needs to make sure that the text embedding vector is fair with respect to the term bank like {Male, Female} for gender, {Black, Latino, White, East Asian} for race, {child, adult} for age, etc. Here, the objective would be to make the distances from “a photo of a {term of interest}” to each “a photo of a {biased} {term of interest}” equally close.

For example, when {term of interest} is an occupation like a “doctor,” there may be a specified {biased} adjective list from the term of gender bank, e.g., “male” and “female.” The objective in this case will be to maximize the similarity between “a photo of a doctor” and the average of “a photo of a male doctor” and “a photo of a female doctor.” To this end, bias pruning process 248 may apply a binary mask to the original model (i.e., generative AI model 402) to generate a pruned model (i.e., debiased model 408) given the bias term(s) and a certain sparsity ratio. In some implementations, bias pruning process 248 may obtain the sparsity ratio via a user interface, such as in conjunction with term(s) of interest 404, term(s) of bias 406, etc. In other implementations, the sparsity ratio may be predefined or computed by bias pruning process 248 on the fly. With such designed objective given the bias term bank and a given sparsity ratio, bias pruning process 248 may prune the text encoder accordingly, resulting in a binary mask with the same shape as the text encoder.

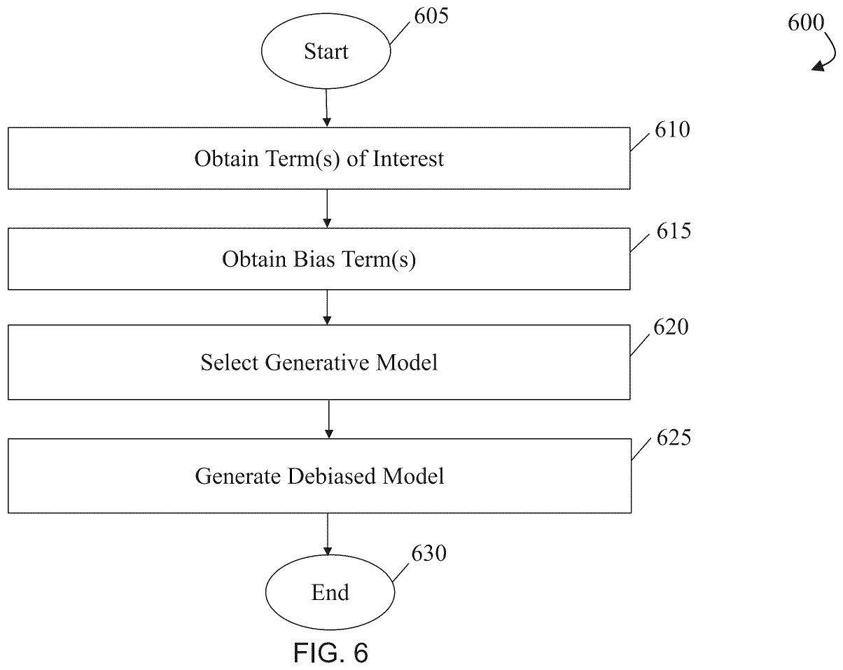

FIG. 6 illustrates an example simplified procedure for ensuring fairness in a generative AI model via model pruning, in accordance with one or more implementations described herein. For example, a non-generic, specifically configured device (e.g., device 200), may perform procedure 600 (e.g., a method) by executing stored instructions (e.g., bias pruning process 248). The procedure 600 may start at step 605, and continues to step 610, where, as described in greater detail above, the device (e.g., a controller, server, endpoint, etc.) may obtain one or more terms of interest. In various implementations, the device obtains the one or more terms of interest via a user interface. In some instances, the one or more terms of interest correspond to one or more types of people (e.g., a person having a particular occupation, ethnicity, race, etc.).

At step 615, as detailed above, the device may obtain one or more bias terms. In various implementations, the device obtains the one or more bias terms via a user interface. In some cases, the one or more bias terms correspond to at least one of: a race, an ethnicity, or a gender.

At step 620, the device may select a generative model configured to generate an output given a textual prompt, as described in greater detail above. In some implementations, the device selects the generative model based on a selection of the generative model by a user via a user interface. In various implementations, the generative model is a text-to-image diffusion model. In some cases, the output comprises an image depicting a person.

At step 625, as detailed above, the device may generate a debiased model by pruning neuron connections in a text encoder of the generative model associated with the one or more terms of interest and the one or more bias terms. In one implementation, the device may also obtain a sparsity ratio and prune the generative model by applying a binary mask to its text encoder based on the sparsity ratio. In turn, the device may also deploy the debiased model in replacement for the generative model.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce an approach for ensuring fairness in a generative AI model via model pruning. As would be appreciated, this approach is not dependent on curation of the training dataset for the model, instead focusing on instead using pruning to remove bias from an existing, trained model. Further aspects of the techniques herein provide for a user interface that allows a user to specify the term(s) of interest, bias term(s), sparsity ratio, and/or other control parameters, to steer the debiasing of the model.

While there have been shown and described illustrative implementations that provide for ensuring fairness in a generative AI model via model pruning, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, one or more terms of interest;
obtaining, by the device, one or more bias terms;
selecting, by the device, a generative model configured to generate an output given a textual prompt; and
generating, by the device, a debiased model by pruning neuron connections in a text encoder of the generative model associated with the one or more terms of interest and the one or more bias terms.

2. The method as in claim 1, wherein the device obtains the one or more terms of interest via a user interface.

3. The method as in claim 1, wherein the device obtains the one or more bias terms via a user interface.

4. The method as in claim 1, wherein the device selects the generative model based on a selection of the generative model by a user via a user interface.

5. The method as in claim 1, wherein the generative model is a text-to-image diffusion model.

6. The method as in claim 1, wherein the output comprises an image depicting a person.

7. The method as in claim 1, further comprising:
obtaining, by the device, a sparsity ratio, wherein the device prunes the generative model by applying a binary mask to its text encoder based on the sparsity ratio.

8. The method as in claim 1, wherein the one or more terms of interest correspond to one or more types of people.

9. The method as in claim 1, wherein the one or more bias terms correspond to at least one of: a race, an ethnicity, or a gender.

10. The method as in claim 1, further comprising:
deploying the debiased model in replacement for the generative model.

11. An apparatus, comprising:
one or more network interfaces;
a processor coupled to the one or more network interfaces and configured to execute one or more processes; and
a memory configured to store a process that is executable by the processor, the process when executed configured to:
obtain one or more terms of interest;
obtain one or more bias terms;
select a generative model configured to generate an output given a textual prompt; and
generate a debiased model by pruning neuron connections in a text encoder of the generative model associated with the one or more terms of interest and the one or more bias terms.

12. The apparatus as in claim 11, wherein the apparatus obtains the one or more terms of interest via a user interface.

13. The apparatus as in claim 11, wherein the apparatus obtains the one or more bias terms via a user interface.

14. The apparatus as in claim 11, wherein the apparatus selects the generative model based on a selection of the generative model by a user via a user interface.

15. The apparatus as in claim 11, wherein the generative model is a text-to-image diffusion model.

16. The apparatus as in claim 11, wherein the output comprises an image depicting a person.

17. The apparatus as in claim 11, wherein the process when executed is further configured to:
obtain a sparsity ratio, wherein the apparatus prunes the generative model by applying a binary mask to its text encoder based on the sparsity ratio.

18. The apparatus as in claim 11, wherein the one or more terms of interest correspond to one or more types of people.

19. The apparatus as in claim 11, wherein the one or more bias terms correspond to at least one of: a race, an ethnicity, or a gender.

20. A tangible, non-transitory, computer-readable medium storing program instructions that cause a device to execute a process comprising:
obtaining, by the device, one or more terms of interest;
obtaining, by the device, one or more bias terms;
selecting, by the device, a generative model configured to generate an output given a textual prompt; and
generating, by the device, a debiased model by pruning neuron connections in a text encoder of the generative model associated with the one or more terms of interest and the one or more bias terms.
